(19) United States
(12) Patent Application Publication
(10) Pub. No.: US 2015/0120438 A1
(43) Pub. Date: Apr. 30, 2015

(54) SYSTEMS AND METHODS FOR AN INTEGRATED AND FRICTIONLESS CALL TRACKING SERVICE

(71) Applicant: BLUE SURF MARKETING, INC., Venice, CA (US)

(72) Inventors: Samuel W. Gilberd, Venice, CA (US); Garrett J. Woodworth, Santa Monica, CA (US)

(21) Appl. No.: 14/527,455

(22) Filed: Oct. 29, 2014

Related U.S. Application Data
(63) Continuation of application No. 13/681,723, filed on Nov. 20, 2012, now abandoned.

(51) Int. Cl. G06Q 30/02

(52) U.S. Cl. CPC G06Q 30/0246
USPC 705/14.45

(57) ABSTRACT

The field of the invention relates to systems and methods for operation of a call tracking service, and more particularly to systems and methods that provide a call tracking service that does not require landing pages operated by the advertisers and still provide granular visibility into the actual ad impressions. In a preferred embodiment, the system includes a call tracking server system, a webserver, an advertiser system coupled to a public network and accessible to one or more users. The call tracking server system includes a database that stores user profile data associated with the one or more users. The system is configured to provide one or more URLs that replace one or more URLs supported by the advertiser system, create a user profile storing data received from and related to the user and the device operated by the user, provide a tracking number, acting as an identifier, for display at a device operated by a user, forward call from the user to the advertiser system, and update the user profile with information relating to the call.

### CROSS-REFERENCE TO RELATED APPLICATIONS

This application is a continuation of U.S. patent application Ser. No. 13/681,723, filed Nov. 20, 2012. The contents of this priority document and all other references disclosed herein are incorporated in their entirety for all purposes.

### FIELD OF THE INVENTION

The field of the invention relates to systems and methods for call tracking services, and more particularly to systems and methods that track calls from advertisements without relying on the landing pages of the advertisers.

### BACKGROUND OF THE INVENTION

In the United States, advertisers will spend sixty billion dollars this year across all media to get new customers on the phone. Ideally, those advertisers would like to know exactly which purchased media drove the highest number of new customers. The advertisers have relied on a method of call tracking that involves the placement of an intermediary phone number between the media, or the advertisement, and the advertiser's inbound phone number. For example, an advertiser may place the number 888-888-8888 on billboard #1 and 999-999-9999 on billboard #2. A consumer who calls either number is forwarded to the advertiser's actual phone number, e.g., 777-777-7777, which may connect to the call center sales office where a sales representative would answer the caller's questions and sign the caller up as a lead or a client. The consumer who dials the original number is not aware of any call forwarding, the phone number rings just like at any other time. However, the advertiser is now able to see that billboard #1 results in, e.g., 50 phone calls and 10 new customers while billboard #2 results in, e.g., only 5 customers. Because the advertiser knows how much it is willing to pay for a new customer (Cost Per Acquisition, or CPA) and how much it spends on the billboard ad spends (spending on ads), they can calculate a Return on Ad Spend (ROAS). Utilizing this metric, advertisers can then decide which billboards are more valuable at generating new customers and which ones they would buy in the future. This is called “optimization” of the media plan.

The billboard example above is one of the offline media channels that can drive calls. Other examples currently include, e.g., yellow pages, print ads, direct mail, and direct response TV. For the past ten years, advertisers have also focused on the Internet as a tool to drive leads for their companies and their clients. They use technology to manage and place advertisements onto various subsections of the Internet and websites, which enables them to measure how many times an ad was seen, how many users clicked on it, how long those users stayed on their sites, and whether that particular advertising placement led to a sale or a new lead, or “conversion.” As a result, an industry was born from the sheer number of possible permutations of ad placements and different websites they may appear in. The industry is called ad serving or digital analytics, and is dominated by companies such as DoubleClick (now owned by Google), Atlas (Microsoft) and Omniture (Adobe).

More recently, Internet browsing by mobile device is on the rise and will soon overtake wired internet browsing performed on PC. Market research firm IDC predicts that by 2015, more users will access the Internet wirelessly via a mobile device than from a wired Ethernet connection. Today, a user browsing the Internet on his mobile device might see an ad, e.g., for auto insurance. When he touches or clicks on the ad on his smartphone, instead of being directed to a web page with a form to fill out and have someone get back to him, as might happen on a computer, the user is prompted to dial a phone number and speak to someone at the auto insurance company immediately to receive a quote. This type of lead is understandably more valuable to the advertiser, as the user reaches out for the product or service right at the moment of seeing an ad, and is therefore a quality prospect. It is also a much more efficient path for the advertiser's media spend, as the advertiser can easily draw a direct connection between how much they spent on the advertisement and how many calls they received, similar to the billboard example above.

Internet browsing on mobile device has increased the quantity of inbound phone calls to advertisers. Yet most of the advertising management tools and ad servers lose track of the user when the user dials from an ad unit (“click to call”), because they lack the ability to track phone numbers and forward calls. Advertisers cannot determine which ad drives the call and are unable to effectively optimize media spends. They may be able to measure how many people see the ad, and how many people touch or click it—but if the user actually dials a number, the ad server is blind to that activity. Separate call tracking systems are an option for reporting on the phone call, but merging the call tracking data and the ad server data is arduous, time consuming, and ineffective. In most cases, advertisers do not know which particular ad prompted the call. They cannot see the actual ad impression which may have generated an inbound call, unless there is a 1-1 correlation between a unique tracking phone number and an ad impression. Even if it were technically possible today, there would be a near impossible complexity in order to assign a fixed tracking phone number to every individual ad impression. As a result, the advertisers are unable to effectively optimize their media budgets.

Some advertisers have resorted to renting a phone line and paying for the amount of time someone is on the phone. For example, the company in the billboard example needs two toll free numbers, for which they might be charged 4 to 15 dollars per month. Then they have to pay the call tracking provider (analogous to a small phone company) per minute for every minute or partial minute someone is using that tracking line. The disadvantage with this model is that digital marketers may have thousands of different permutations, or ad placements and sites where the ads appear, that they need to track in order to optimize their media plans effectively. If they had one phone number for each ad placement, it would be cost prohibitive; plus the phone companies would run out of phone numbers very quickly. As a result, some advertisers, using current call tracking services, e.g., RingRevenue, may be able to track only the publishers, media channels, or a limited number of the overall media plan's placements, e.g., one number for all ads on TV, one number for all ads on PC, one number for all ads on billboards, and one number for all ads on mobile devices. Moreover, while an advertiser may assign a particular phone number to all the inbound traffic generated by a particular network, neither the network nor the advertiser is able to find out exactly which source of ad impressions may have generated a higher (or lower) number of actual inbound phone calls.

In the cases where advertisers use Google's adwords search engine marketing program, there may be tens of thousands of keywords. One current option, e.g., as used by RingRevenue and Mongoose Metrics, is to offer advertisers the ability to use a limited number of phone lines to track a large number of keywords. This solution depends on the use of web “landing pages” to which the user is directed after clicking on an ad. When the user clicks a keyword, he is directed to a landing page where that number is displayed. Then the user must click on the phone number to engage the device's dialer and initiate a call. However, much of the mobile advertising world today is not using landing pages for their campaigns. Instead, they drive phone calls directly from the ad unit via click-to-call method.

Accordingly, improved systems and methods to provide a call tracking service that does not require landing pages operated by the advertisers and still provide granular visibility into the actual ad impressions, e.g., more visibility into the publisher where the advertisement was shown, identification of the caller, duration of the call, and so on, may be desirable.

### SUMMARY OF THE INVENTION

The field of the invention relates to systems and methods for operation of a call tracking service, and more particularly to systems and methods that provide a call tracking service that does not require landing pages operated by the advertisers and still provide granular visibility into the actual ad impressions.

In an exemplary embodiment, the system includes a call tracking server system, a webserver, an advertiser system coupled to a public network and accessible to one or more users. The call tracking server system includes a database that stores user profile data associated with the one or more users. The system is configured to provide one or more URLs that replace one or more URLs supported by the advertiser system (also referred herein as original landing page URLs, or advertiser URLs), create a user profile storing data received from and related to the user and the device operated by the user, provide a tracking number (acting as an identifier) for display at a device operated by a user, forward call from the user to the advertiser system, and update the user profile with information relating to the call.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1a is an exemplary diagram of a call tracking system in accordance with a preferred embodiment of the present invention;

FIG. 1b is an exemplary diagram of a CallServer system in accordance with a preferred embodiment of the present invention;

FIG. 1c is another exemplary diagram of a CallServer system in accordance with a preferred embodiment of the present invention;

FIG. 2 is an exemplary user interface in accordance with a preferred embodiment of the present invention;

FIG. 2a is another exemplary user interface in accordance with a preferred embodiment of the present invention;

FIG. 3 is another exemplary user interface in accordance with a preferred embodiment of the present invention;

FIG. 4 is an exemplary process of a call tracking system in accordance with a preferred embodiment of the present invention.

FIG. 5 is another exemplary process of a call tracking system in accordance with a preferred embodiment of the present invention.

### DETAILED DESCRIPTION OF THE PREFERRED EMBODIMENTS

### Preferred Systems

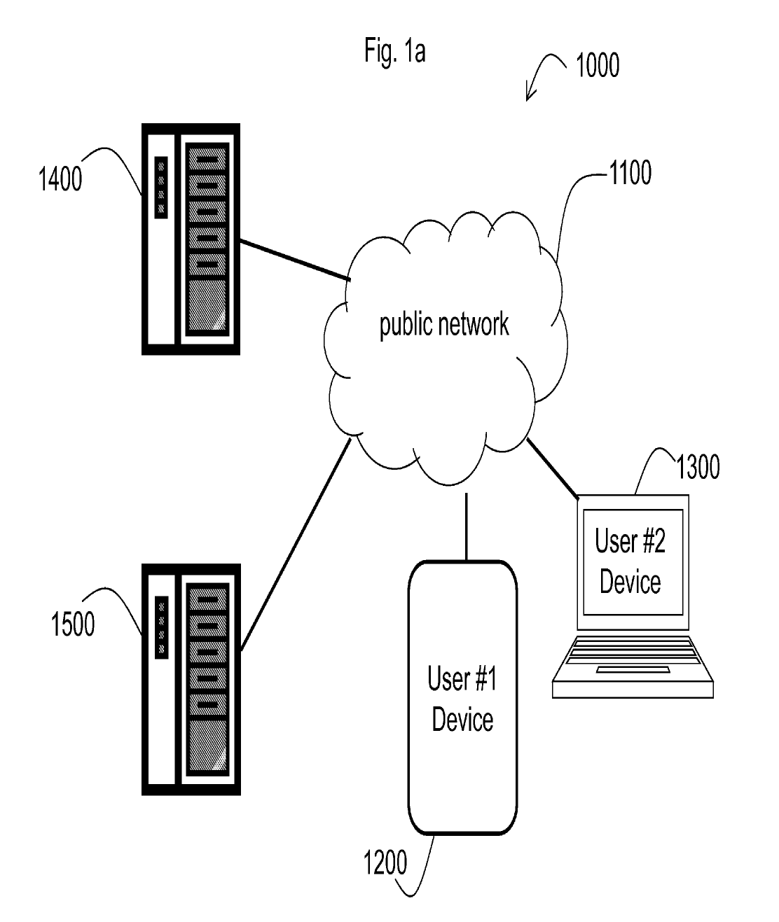

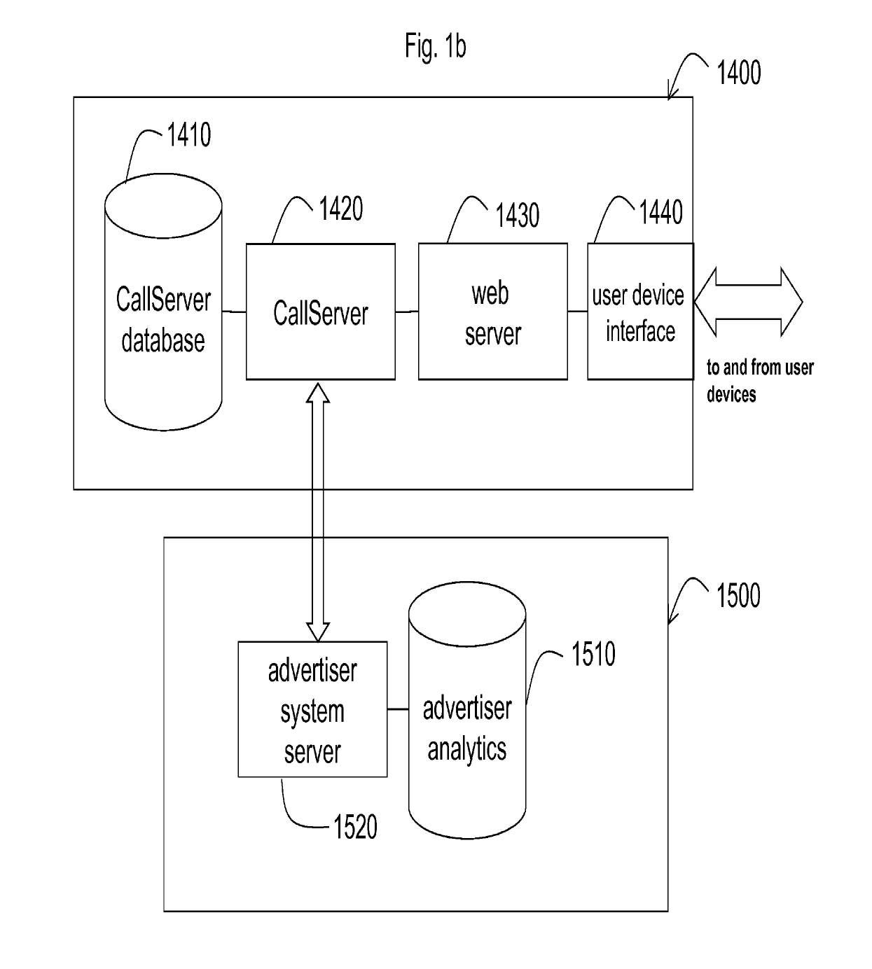

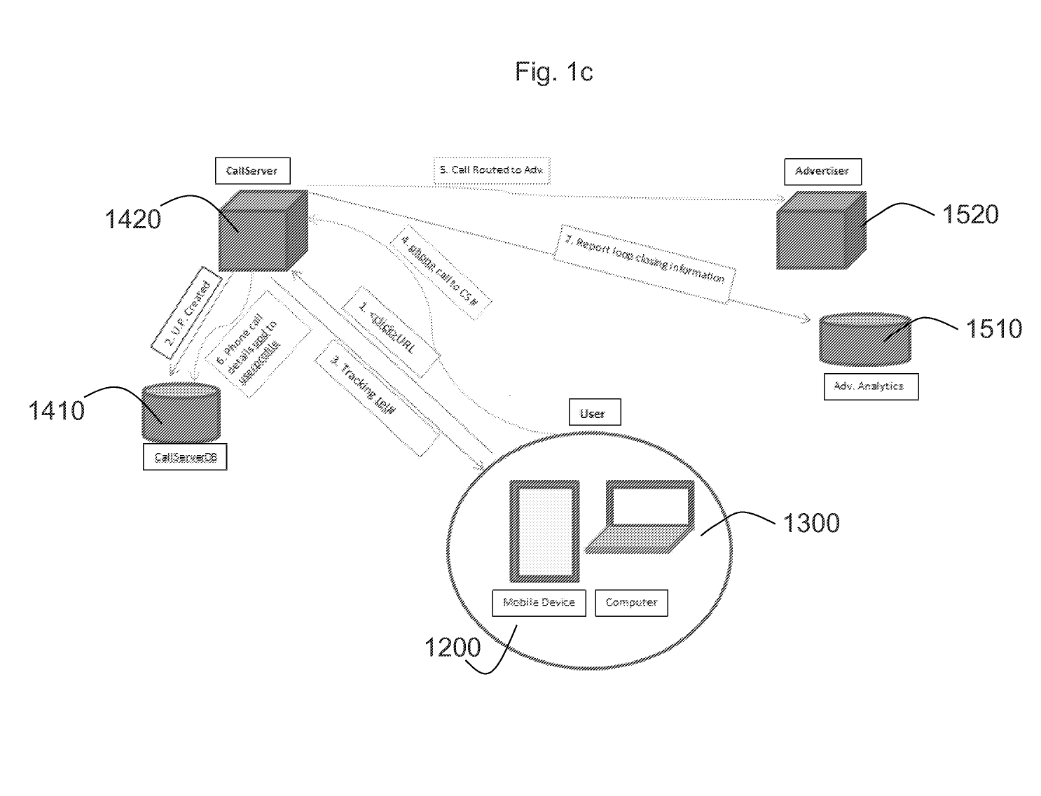

Turning to FIG. 1a, a computer-based call tracking system 1000 in accordance with a preferred embodiment of the present invention is shown. The system 1000 generally includes a call tracking system 1400 which may be distributed on one or more physical servers, each having processor, memory, an operating system, and input/output interface, and a network interface all known in the art, an advertiser system 1500, and a plurality of end user computing devices 1200/1300 coupled to a public network 1100, such as the Internet and/or a cellular-based wireless network.

Turning to the call tracking system 1400, a preferred embodiment is shown in FIG. 1b. Generally, the call tracking system 1400 includes a webserver 1430 designed to provide web services to consumers (web users). The terms user, visitor and consumer are used interchangeably herein. The call tracking system 1400 also includes a CallServer 1420 designed to provide click-to-call service, route calls, and provide call metrics and analytics. The call routing functions may be performed by a softswitch server which may be integrated with the CallServer 1420, or which may be a server coupled to the call tracking system 1400, in accordance with methods and technologies known in the art.

The CallServer 1420 communicates with one or more advertiser systems 1500 to exchange ad campaign data. Generally, the CallServer 1420 replaces one or more landing page URLs in an advertisement with one or more URLs (e.g., www.callsrvr.net/123jkl, of which the extension “123jkl” is associated with an internal CallServer campaign, consisting of an advertiser's destination phone number and other accompanying data including, e.g., format of preferred reporting method by which and location to which the CallServer 1420 will ultimately report activity to the advertiser (typically referred to as a “postback pixel code” or “endpoint”). Through the URLs supported by the tracking system 1400, when a user at a user device 1200/1300 touches or clicks on an ad unit, the CallServer 1420 receives and processes the request. The CallServer 1420 associates the request with a particular campaign, and returns to the user device 1200/1300 a phone number unique to the user's profile (as described below) at that particular time. The phone number is preconfigured for use by the CallServer 1420 to forward a call from the user to the advertiser. The format in which the Callserver 1420 sends the data to the user device 1200/1300 propagates and populates the dialer of the device 1200/1300. Additional data may also be appended to the URL, e.g., in using parameter={parameter}, and ‘passed’ to the Callserver 1420 on the initial user click. This data is stored and may be returned to the advertiser along with all of the data heretofore collected and pertaining to the call, should it be required. In addition, the original landing page URL which was replaced by a CallServer URL may be loaded in the user device browser. If the user does not immediately dial and instead closes the dialer, the user will see the original landing page of the given advertisement within which there will be the same CallServer phone number. It is noted that no phone number needs to be listed in the ad.

The CallServer 1420 keeps ad-related data in a CallServer database 1410. These data include, e.g., advertiser ID, advertiser URLs, call tracking system URLs (including CallServer AdCode), ad campaign ID, advertiser phone number, original landing page, and so on. When a user touches or clicks on an ad unit, the CallServer 1420 also creates a user profile for that user in the CallServer database 1410. Data stored in a user profile include, e.g., CallServer campaign ID, user device 1200/1300 information, browser information, caller ID, time, and placement, reference, or advertiser provided data, and so on. When a call to the advertiser completes, the CallServer 1420 also updates the user profile with metrics and analytics data from the call. This data may include, for example, timestamp of call, call duration, any recording, any transcript, and so on. Such transcript and recording data can be used for additional data mining analysis. Based on a predetermined arrangement with the advertiser, the CallServer 1420 may also send the call metrics and analytics data to the advertiser system 1500.

Turning to FIG. 1e, another preferred embodiment of the call tracking system 1400 is shown. As mentioned above, the call tracking system 1400 may be distributed on one or more physical servers. For example, the CallServer database 1410 may be integrated with the CallServer 1420 (FIG. 1b), or it may be a server coupled to the call tracking system 1400.

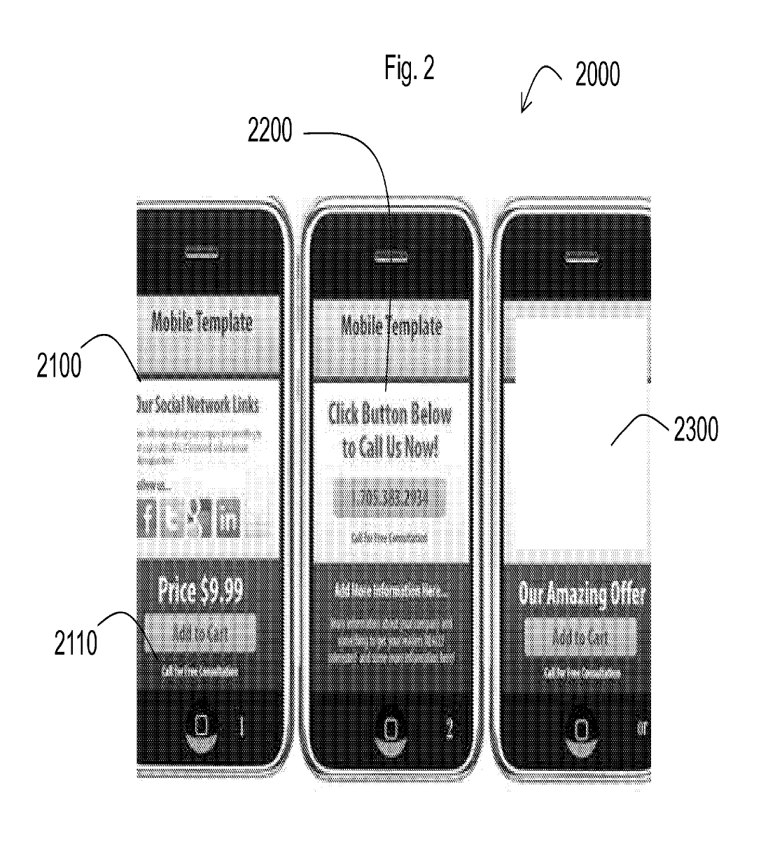

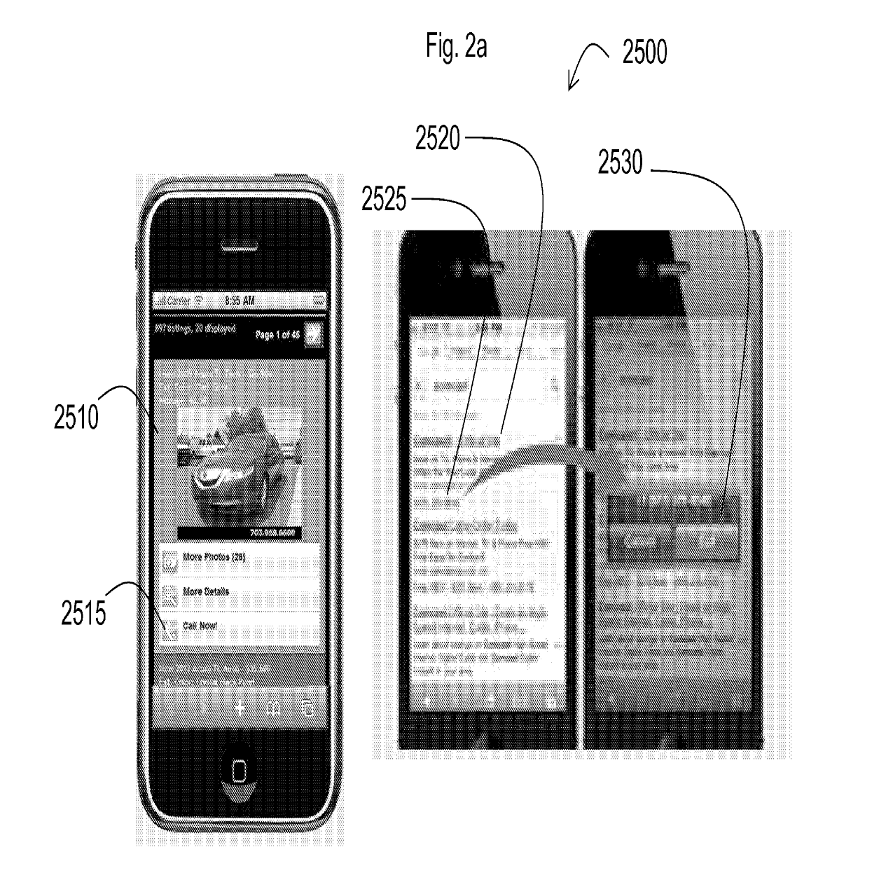

Turning to FIG. 2, in accordance with a preferred embodiment, an example of the CallServer user interface 2000 is shown. The CallServer user interface 2000 is powered by the CallServer 1420. The CallServer user interface 2000 generally provides an ad 2100 with an invitation 2110 to the user to make a call. When the user touches or clicks on the invitation 2110, the CallServer 1420 provides a click-to-call display 2200. When the user touches or clicks on the click-to-call display 2200, the CallServer 1420 routes the call to the advertiser system 1500, which provides display 2300.

Turning to FIG. 2a, in accordance with a preferred embodiment, an ad 2510 is shown with an invitation 2515 to the user to make a call. Another exemplary ad 2520 is shown with an invitation 2525 to the user to make a call. When the user touches or clicks on the invitation 2525, the CallServer 1420 provides a click-to-call display 2530. The click-to-call display 2530 shows the user device's dialer which has been propagated with a CallServer phone number.

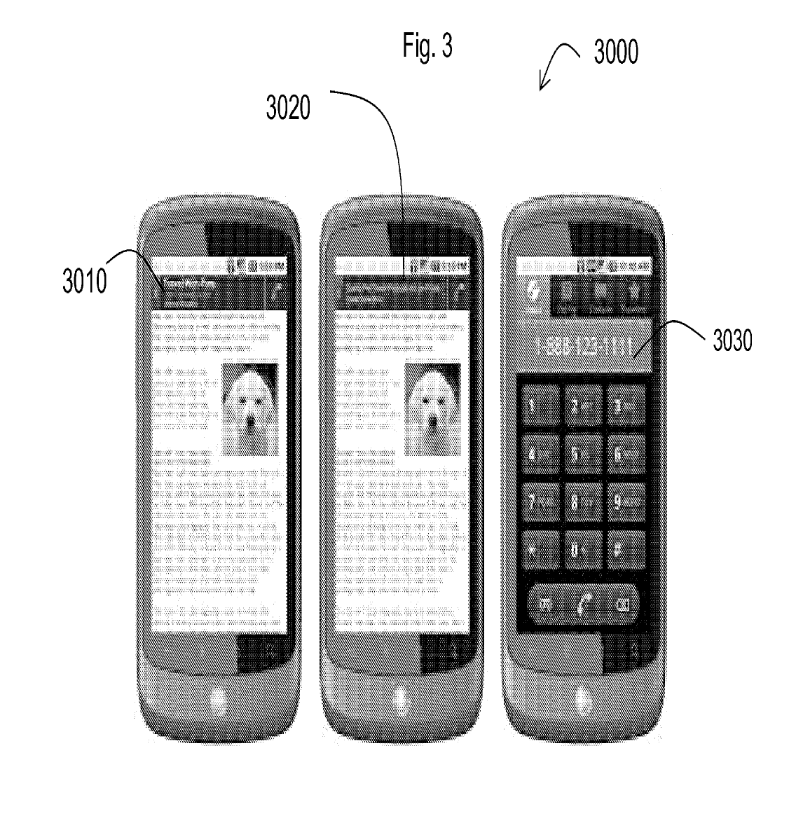

Turning to FIG. 3, in accordance with a preferred embodiment, a banner advertisement 3010/3020 is shown. When the user touches or clicks on the banner advertisement 3010/3020, the CallServer 1420 provides a click-to-call display 3030. The click-to-call display 3030 shows the user device's dialer which has been propagated and populated with a CallServer phone number.

### Preferred Processes

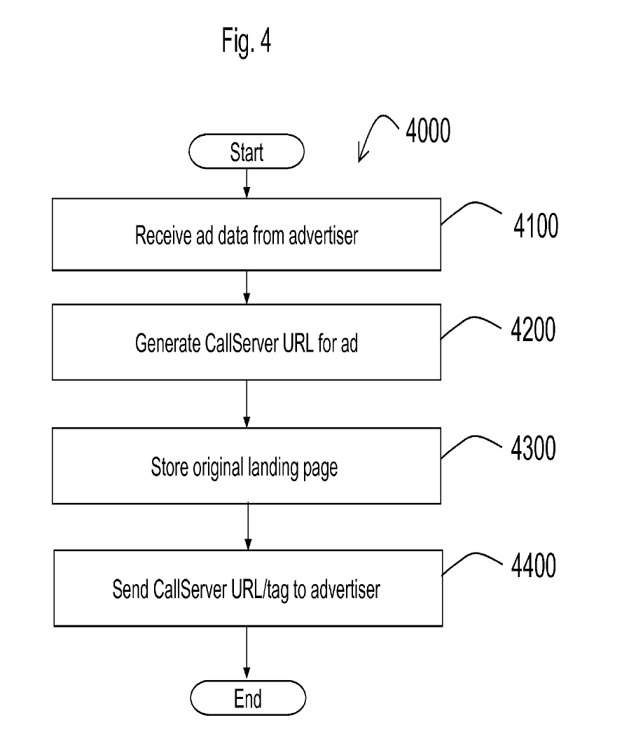

Turning to FIG. 4, a description of the operation 4000 of the CallServer's call tracking process is shown. When an advertiser wants to display an ad at a user device 1200/1300, the advertiser system 1500 provides ad data to the call tracking system 1400 (Action Block 4100). As mentioned above, the data include, e.g., advertiser ID, advertiser phone number, one or more advertiser URLs (landing pages for banner, search, email, etc.), ad campaign ID, and so on. The CallServer 1420 generates one or more call tracking system (or CallServer) URLs based on the data (Action Block 4200) and stores the one or more original advertiser URLs in the CallServer database 1410 (Action Block 4300). The CallServer 1420 then sends the generated one or more URLs to the advertiser for use in the ad (Action Block 4400). Each CallServer URL is associated with a CallServer campaign. For example, an ad 2520 (FIG. 2a) for a widget company may have a click-to-call tag or click to original landing page at www.widgetcompany.com. After receiving a CallServer URL generated by the CallServer 1420, the advertiser replaces this landing page URL in the ad with the assigned CallServer URL, which is associated with a unique (or temporarily unique) tracking phone number, resulting in, e.g., the CallServer URL www.callsrvr.net/abc123, acting as the click-to-call tag or click to “landing page” 2525 in the ad.

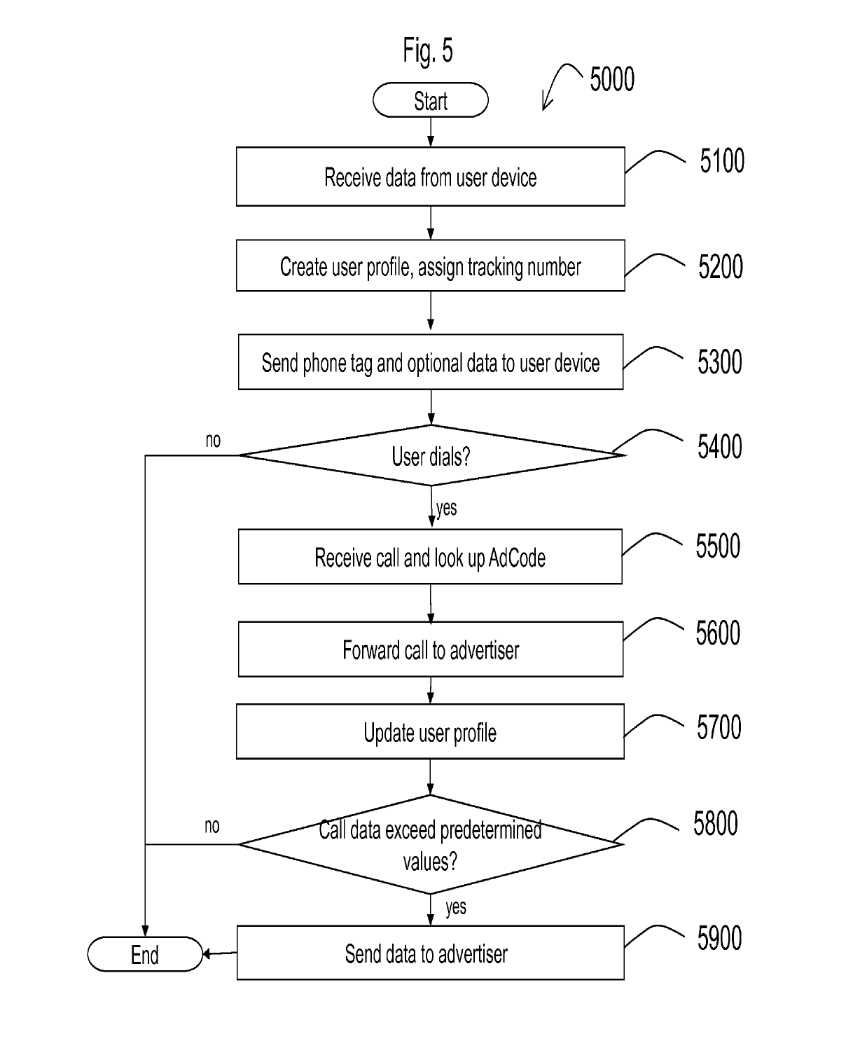

Turning to FIG. 5, a description of the operation 5000 of the CallServer's call tracking process is shown. When a user clicks on the click-to-call tag or click to landing page 2525, the CallServer 1420 receives the CallServer URL (www.callsrvr.net/abc123) as well as information related to the user device 1200/1300 (Action Block 5100). The CallServer 1420 creates a user profile (Action Block 5200) to store the captured information. As mentioned above, the data include, e.g., user device information (brand, service provider, input device, operating system, screen resolution, location, etc.), browser information, referrer, caller ID, time, and placement, reference, or advertiser provided additional data parameters, and so on. Based on the CallServer URL, the CallServer 1420 determines the advertiser ID, advertiser phone number, one or more advertiser URLs (landing pages for banner, search, email, etc.), ad campaign ID, and so on. The CallServer 1420 also assigns a tracking phone number to be associated with the user for a predetermined period of time. If the user returns and/or clicks on the click-to-call tag or click to landing page 2525 within this period of time, the CallServer 1420 may use the same user profile and tracking phone number.

The CallServer 1420 sends to user device 1200/1300 a phone tag (2530 in FIG. 2a) (Action Block 5300) in a format (e.g., in HTML5) that would display the tracking phone number which is propagated into the dialer of the user device 1200/1300. The CallServer 1420 may also send to the user device 1200/1300 the URL of the original advertiser landing page. This landing page optionally includes a specified region of the webpage which either contains the same CallServer URL, which upon being selected or clicked by the user would load the same phone tag from the CallServer, showing the same tracking phone number, or the region may be populated with the temporary tracking phone number already assigned to the particular user profile from an earlier request and may be represented in a format indicating that the number is a phone number. The above can be sent either in the same transaction or in separate transactions. The Call Server 1420 also stores one or more cookies in the user device 1200/1300 with data including, e.g., CallServer tracking phone number, CallServer campaign ID, date, time, and so on. Alternatively, the CallerServer 1420 only stores the data in the CallServer database 1410. The data may also be used for data mining purposes.

If the user touches or clicks on the phone tag 2530 (or a link) to initiate the call (Decision Block 5400), the CallServer 1420 receives the call, and looks up the AdCode (Action Block 5500). It is noted that when the AdCode includes up to 5 digits, the CallServer 1420 can support upward to about 100,000 distinct permutation attributes which may be a combination of, e.g., advertisement unit, publisher location, time/date stamp, etc, to the same tracking phone number and which may be used to communicate all of the information in a different fashion. When the user dials the tracking phone number, upon connection to the Callserver 1420, the AdCode is automatically dialed (similar to an extension) and detected by the CallServer 1420, which can then translate the AdCode to determine the origin of the call according to a predefined table, for instance, and update the user profile with new data. This method may be used for advertisers wishing to use ‘vanity’ toll free phone numbers. For example, 1-800 DENTIST could be represented in the dialer upon first click of the CallServer URL. In accordance with the as yet undefined W3 standards, the particular method of passing the AdCode to the phone call could be as follows, HTML5 <tel:1800DENTIST,ext:12345>. The AdCode is also attached to the call event. The CallServer then forwards or routes the call to the advertiser phone number (Action Block 5600). At this time, the user's caller ID is stored in the user profile.

When the call terminates, the Call Server 1420 updates the user profile with the call information (Action Block 5700). The information includes, e.g., call duration, date, timestamp, key presses, URL to any recording, etc. The CallServer 1420 determines whether the call (or call metrics and analytics) meets or exceeds one or more predetermined values, e.g., call duration of at least 2 minutes (Decision Block 5800). If the one or more predetermined values are met or exceeded, the CallServer 1420 sends predetermined data to the advertiser system 1500 (Action Block 5900).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for tracking calls from communication devices; however, the invention can be used for any call tracking system in general. Additionally and obviously, features may be added or subtracted as desired. Accordingly, the invention is not to be restricted except in light of the attached claims and their equivalents.

What is claimed is:

1. A computer-based system for call tracking, comprising:
a call tracking server system, operatively coupled to a webserver, an advertiser system, and a public network, having a database that stores profiles of a plurality of users, wherein the call tracking server system is configured to:
generate one or more URLs that replace one or more URLs supported by the advertiser system;
receive input from a device operated by a user of the plurality of users;
create a user profile storing data received from and related to the user and the device operated by the user;
generate and provide an identifier for display at the device operated by the user;
receive request to make a call from the device operated by the user;
forward the call to the advertiser system; and
update the user profile with information relating to the call.

2. The computer-based system of claim 1, further configured to send predetermined data stored in the user profile to the advertiser system.

3. The computer-based system of claim 1, further configured to send call metrics data to the advertiser system.

4. The computer-based system of claim 1, further configured to send call analytics data to the advertiser system.

5. The computer-based system of claim 3, wherein the system sends call metrics data to the advertiser system when one or more metrics data meet or exceed one or more predetermined values.

6. The computer-based system of claim 4, wherein the system sends call analytics data to the advertiser system when one or more analytics data meet or exceed one or more predetermined values.

7. The computer-based system of claim 1, wherein the identifier is propagated in a dialer at the device operated by the user.

8. The computer-based system of claim 1, wherein the generated URL includes an AdCode.
